(19) United States
(12) Patent Application Publication
(10) Pub. No.: US 2007/0124145 A1
(43) Pub. Date: May 31, 2007

(54) METHOD AND APPARATUS FOR ESTIMATING DISCRIMINATING ABILITY OF A SPEECH, METHOD AND APPARATUS FOR ENROLLMENT AND EVALUATION OF SPEAKER AUTHENTICATION

(75) Inventors: Jian Luan, Beijing (CN); Jie Hao, Beijing (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/550,525

(22) Filed: Oct. 18, 2006

(30) Foreign Application Priority Data
Nov. 11, 2005 (CN) 200510114901.4

(51) Int. Cl. G10L 15/04

(52) U.S. Cl. 704/254

(57) ABSTRACT

The present invention provides a method and apparatus for enrollment and evaluation of speaker authentication, a method for estimating discriminating ability of a speech, and a system for speaker authentication. A method for enrollment of speaker authentication, comprising: inputting a speech containing a password that is spoken by a speaker; obtaining a phoneme sequence from said inputted speech; estimating discriminating ability of the phoneme sequence based on a discriminating ability table that includes a discriminating ability for each phoneme; setting a discriminating threshold for said speech; and generating a speech template for said speech.

### TECHNICAL FIELD

The present invention relates to information processing technology, specifically to the technology of speaker authentication and estimation of discriminating ability of a speech.

### TECHNICAL BACKGROUND

By using pronunciation features of each speaker when he/she is speaking, different speakers may be identified, so as to make speaker authentication. In the article “Speaker recognition using hidden Markov models, dynamic time warping and vector quantisation” written by K. Yu, J. Mason, J. Oglesby (Vision, Image and Signal Processing, IEE Proceedings, Vol. 142, October 1995, pp. 313-18), commonly used three kinds of speaker identification engine technologies have been introduced: HMM, DTW and VQ.

Generally, a speaker authentication system includes two phases: enrollment and evaluation. To realize a high reliable system (such as HMM-based one) by using the above-mentioned prior-art technologies for speaker identification, the enrollment phase usually is semiautomatic, in which developer produces a speaker model with multiple speech samples supplied by clients and a decision threshold through experiments. The number of speech samples for training may be great and even the password samples uttered by other persons are required for a cohort model. Thus, the enrollment is time-consuming and it is impossible to alter the password freely by a client without participation of the developer. Thus it is inconvenient for a client to use such a system.

On the other hand, some phonemes or syllables in a given password may lack discriminating ability among different speakers. However, no such kinds of inspection for password effectiveness are made during enrollment in most present systems.

### SUMMARY OF THE INVENTION

In order to solve the above-mentioned problems in the prior technology, the present invention provides a method and apparatus for enrollment of speaker authentication, a method and apparatus for evaluation of speaker authentication, a method for estimating discriminating ability of a speech, and a system for speaker authentication.

According to an aspect of the present invention, there is provided a method for enrollment of speaker authentication, comprising: inputting a speech containing a password that is spoken by a speaker; obtaining a phoneme sequence from the inputted speech; estimating discriminating ability of the phoneme sequence based on a discriminating ability table that includes a discriminating ability for each phoneme; setting a discriminating threshold for the speech; and generating a speech template for the speech.

According to another aspect of the present invention, there is provided a method for evaluation of speaker authentication, comprising: inputting a speech; and determining whether the inputted speech is an enrolled password speech spoken by the speaker according to a speech template that is generated by using a method for enrollment of speaker authentication mentioned above.

According to another aspect of the present invention, there is provided a method for estimating discriminating ability of a speech, comprising: obtaining a phoneme sequence from the speech; and estimating discriminating ability of the phoneme sequence based on a discriminating ability table that includes a discriminating ability for each phoneme.

According to another aspect of the present invention, there is provided an apparatus for enrollment of speaker authentication, comprising: a speech input unit configured to input a speech containing a password that is spoken by a speaker; a phoneme sequence obtaining unit configured to obtain a phoneme sequence from the inputted speech; a discriminating ability estimating unit configured to estimate discriminating ability of the phoneme sequence based on a discriminating ability table that includes a discriminating ability for each phoneme; a threshold setting unit configured to set a discriminating threshold for the speech; and a template generator configured to generate a speech template for the speech.

According to another aspect of the present invention, there is provided an apparatus for evaluation of speaker authentication, comprising: a speech input unit configured to input a speech; an acoustic feature extractor configured to extract acoustic features from the inputted speech; and a matching distance calculator configured to calculate the DTW matching distance of the extracted acoustic features and a corresponding speech template that is generated by using a method for enrollment of speaker authentication mentioned above; wherein the apparatus for evaluation of speaker authentication determines whether the inputted speech is an enrolled password speech spoken by the speaker through comparing the calculated DTW matching distance with the predefined discriminating threshold.

According to another aspect of the present invention, there is provided a system for speaker authentication, comprising: an apparatus for enrollment of speaker authentication mentioned above; and an apparatus for evaluation of speaker authentication mentioned above.

### BRIEF DESCRIPTION OF THE DRAWINGS

It is believed that through following detailed description of the embodiments of the present invention, taken in conjunction with the drawings, above-mentioned features, advantages, and objectives will be better understood.

FIG. 1 is a flowchart showing a method for enrollment of speaker authentication according to an embodiment of the present invention;

FIG. 2 is a flowchart showing a method for evaluation of speaker authentication according to an embodiment of the present invention;

FIG. 3 is a flowchart showing a method for estimating discriminating ability of a speech according to an embodiment of the present invention;

FIG. 4 is a block diagram showing an apparatus for enrollment of speaker authentication according to an embodiment of the present invention;

FIG. 5 is a block diagram showing an apparatus for evaluation of speaker authentication according to an embodiment of the present invention;

FIG. 6 is a block diagram showing a system for speaker authentication according to an embodiment of the present invention; and

FIG. 7 is a curve illustrating discriminating ability estimation and threshold setting in the embodiments of the present invention.

### DETAILED DESCRIPTION OF THE INVENTION

Next, a detailed description of the preferred embodiments of the present invention will be given in conjunction with the drawings.

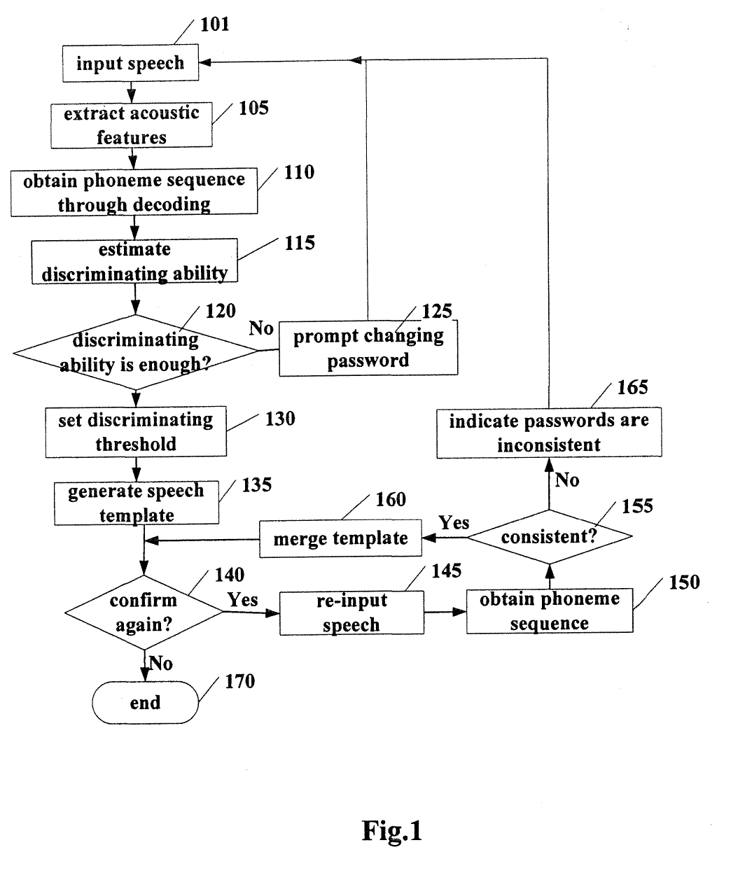

FIG. 1 is a flowchart showing a method for enrollment of speaker authentication according to an embodiment of the present invention. As shown in FIG. 1, first in Step 101, a speech containing a password spoken by a speaker is inputted. Here, the user can freely determine the content of the password and speak it without the need for an system administrator or developer to decide, through consultation with the speaker (user), the content of the password beforehand as done in the prior technology.

Next, in Step 105, acoustic features are extracted from the speech. Specifically, MFCC (Mel Frequency Cepstrum Coefficient) is used to express the acoustic features of a speech in this embodiment. However, It should be noted that, the invention has no specific limitation to this, and any other known and future ways may be used to express the acoustic features of a speech, such as LPCC (Linear Predictive Cepstrum Coefficient) or other coefficients obtained based on energy, fundamental tone frequency, or wavelet analysis, as long as they can express the personal speech features of a speaker.

Next, in Step 110, the extracted acoustic features are decoded to obtain a corresponding phoneme sequence. Specifically, HMM (Hidden Markov Model) decoding is used in this embodiment. However, it should be noted that the invention has no specific limitation to this, and other known and future ways may be used to obtain the phoneme sequence, such as ANN-based (Artificial Neutral Net) model; as to the searching algorithms, various decoder algorithms such as Viterbi algorithm, A* and others may be used, as long as a corresponding phoneme sequence can be obtained from the acoustic features.

Next, in Step 115, discriminating ability of the phoneme sequence is estimated based on a discriminating ability table that includes a discriminating ability for each phoneme. Specifically, the form of a discriminating ability table is that as shown below in Table 1 in this embodiment.

TABLE 1
an example of a discriminating ability table

| Phoneme | μ_{c} | σ_{c}² | μᵢ | σᵢ² |
|---|---|---|---|---|
| a | | | | |
| o | | | | |
| e | | | | |
| i | | | | |
| u | | | | |
| . . . | | | | |

Taking Chinese Mandarin as an example, Table 1 lists the discriminating ability of each phoneme (a minimum unit constructing a speech), that is, 21 initials and 38 finals. For other languages, the composition of phonemes may differ, for instance, English has consonants and vowels, but it can be understood that the invention is also applicable to these other languages.

The discriminating ability table of this embodiment is prepared beforehand through statistics. Specifically, at first, a plurality of speeches of each phoneme is recorded for a certain number (such as, 50) of speakers. Then, for each phoneme, for instance “a”, acoustic features are extracted from the speech data of “a” spoken by all the speakers, and DTW (Dynamic Time Warping) matching is made between each two of them. The matching scores (distances) are divided into two groups: “self” group, into which the scores of matched acoustic data from the same speaker fall; and “others” group, into which the scores from different speakers fall. The overlapping relation between the distribution curves of these two groups of data may characterize the discriminating ability of the phoneme for different speakers. It is known that both groups of data belong to t-distribution. Since the data volume is relatively large, they may be approximately considered to obey the normal distribution. Thus, it is enough to record mean and variance of the score of each group to keep almost all of the distribution information. As shown in Table 1, in a phoneme discriminating ability table, μ_{c} and σ_{c}² corresponding to each phoneme are mean and variance of the self group respectively, and μᵢ and σᵢ² are mean and variance of the others group respectively.

Thus, with a phoneme discriminating ability table, the discriminating ability of a phoneme sequence (a segment of speech containing a text password) can be calculated. Because a DTW matching score is expressed as a distance, the matching distance (score) of a phoneme sequence may be considered as the sum of the matching distances of all phonemes contained in the sequence. Now that the two groups (self group and others group) of matching distances of each phoneme are known to obey distribution parameters N(μ_{cn},σ_{cn}²) and N(μᵢₙ,σᵢₙ²) respectively, the two groups of matching distances of the whole phoneme sequence should obey distribution parameters

$$N ( {\sum }_{n} {μ}_{cn} , {\sum }_{n} {σ}_{cn}^{2} )$$

and

$$N ( {\sum }_{n} {μ}_{i n} , {\sum }_{n} {σ}_{i n}^{2} ) .$$

Thus, with a phoneme discriminating ability table, two groups (self group and others group) of distributions of matching distances may be estimated for any phoneme sequence. Taking “zhong guo” as an example, the parameters of the two groups of distributions of the phoneme sequence are as follows:
μ(zhongguo)=μ(zh)+μ(ong)+μ(g)+μ(u)+μ(o) (1)
σ²(zhongguo)=σ²(zh)+σ²(ong)+σ²(g)+σ²(u)+σ²(o) (2)

Besides, based on the same principle, for those phonemes that are difficult to be pronounced independently, such as initials or consonants, they may be combined with known phonemes to construct an easy pronounced syllable so as to record a speech for making statistics. Then, through a simple subtraction, the statistic data for the phoneme may be obtained, as shown in the following formulas:
μ(f)=μ(fa)−μ(a) (3)
σ²(f)=σ²(fa)−σ²(a) (4)

Besides, according to a preferred embodiment of the present invention, it may be considered to use duration information (i.e., the corresponding number of feature vectors) of each phoneme in a password text to make weighting when calculating distribution parameters of the password text based on a phoneme sequence. For instance, above formulas (1) and (2) may be changed to:

$$\begin{matrix}μ ( zhongguo ) = \frac{\begin{matrix}λ ( zh ) μ ( zh ) + λ ( ong ) μ ( ong ) + \\ λ ( g ) μ ( g ) + λ ( u ) μ ( u ) + λ ( o ) μ ( o )\end{matrix}}{λ ( zh ) + λ ( ong ) + λ ( g ) + λ ( u ) + λ ( o )} & ( 5 ) \\ {σ}^{2} ( zhongguo ) = \frac{\begin{matrix}λ ( zh ) {σ}^{2} ( zh ) + λ ( ong ) {ρ}^{2} ( ong ) + \\ λ ( g ) {σ}^{2} ( g ) + λ ( u ) {σ}^{2} ( u ) + λ ( o ) {σ}^{2} ( o )\end{matrix}}{λ ( zh ) + λ ( ong ) + λ ( g ) + λ ( u ) + λ ( o )} & ( 6 )\end{matrix}$$

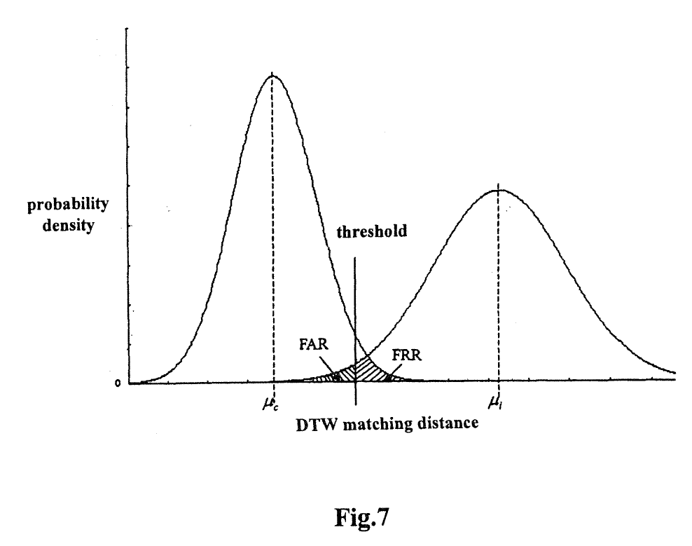

Next, in Step 120, it is determined whether the discriminating ability of above phoneme sequence is enough. FIG. 7 is a curve for illustrating discriminating ability estimation and threshold setting in the embodiments of the present invention. As shown in FIG. 7, through the preceding steps, the distribution parameters (distribution curves) of self group and others group of the phoneme sequence may be obtained. According to this embodiment, there are following three methods for estimating discriminating ability of the password:

a) calculating overlapping area of these two distributions (shaded area in FIG. 7); if the overlapping area is larger than a predetermined value, it is determined that the discriminating ability of the password is weak. b) calculating equal error rate (EER); if the equal error rate is larger than a predetermined value, it is determined that the discriminating ability of the password is weak. Equal error rate (EER) means the error rate when a false accept rate (FAR) is equal to a false reject rate (FRR), that is, the area of either of these two shaded parts when the shaded area in FIG. 7 is divided into left and right parts by the threshold value and these two shaded parts have the same area, c) calculating false reject rate (FRR) when the false accept rate (FAR) is set to a desired value (such as 0.1%); if the false reject rate (FRR) is larger than a predetermined value, it is determined that the discriminating ability of the password is weak.

If in Step 120 it is determined that the discriminating ability is not enough, the process proceeds to Step 125, prompting the user to change the password so as to enhance its discriminating ability, and then returns to Step 101, where the user inputs a password speech once more. If in Step 120 it is determined that the discriminating ability is enough, then the process proceeds to Step 130.

In Step 130, a discriminating threshold is set for the speech. Similar to the case of estimating discriminating ability, as shown in FIG. 7, the following three methods can be used to estimate the optimum discriminating threshold in this embodiment:

a) setting the discriminating threshold as the cross point of the distribution curve of self group and the distribution curve of others group of the phoneme sequence, that is, the place where the sum of FAR and FRR is minimum. b) setting the discriminating threshold as a threshold corresponding to equal error rate. c) setting the discriminating threshold as a threshold that makes false accept rate a desired value (such as 0.1%).

Next, in Step 135, a speech template is generated for the speech. Specifically, in this embodiment the speech template contains acoustic features extracted from the speech and the discriminating threshold set for the speech.

Next, in Step 140, it is determined whether the speech password needs to be confirmed again. If no, the process ends in Step 170; otherwise the process proceeds to Step 145, where the speaker inputs a speech containing a password once more.

Next, in Step 150, a corresponding phoneme sequence is obtained based on the re-inputted speech. Specifically, this step is the same as above steps 105 and 110, of which description is not repeated here.

Next, in Step 155, it is determined whether the phoneme sequence corresponding to the present inputted speech is consistent with the phoneme sequence of the previously inputted speech. If they are inconsistent, then the user is prompted that the passwords contained in both speeches are inconsistent and the process returns to Step 101, inputting a password speech again; otherwise, the process proceeds to Step 160.

In Step 160, the acoustic features of the previously generated speech template and the acoustic features extracted this time are aligned with each other for DTW matching and averaged, that is, template merging is made. About template merging, reference may be made to the article “Cross-words reference template for DTW-based speech recognition systems” written by W. H. Abdulla, D. Chow, and G. Sin (IEEE TENCON 2003, pp.1576-1579).

After template merging, the process returns to Step 140, where it is determined whether another confirmation is needed. According to this embodiment, usually confirmation to the password speech may be made by 3 to 5 times, such that the reliability can be raised and it will not bother the user too much.

From the above description it can be seen that if the method for enrollment of speaker authentication of this embodiment is adopted, a user can select and input a password speech by himself/herself without the need of a system administrator or developer's participation, so that the user can make enrollment more conveniently and get better security. Furthermore, the method for enrollment of speaker authentication of this embodiment can automatically estimate the discriminating ability of a password speech during user's enrollment, so that a user's password speech without enough discriminating ability may be prevented and thereby the security of authentication may be enhanced.

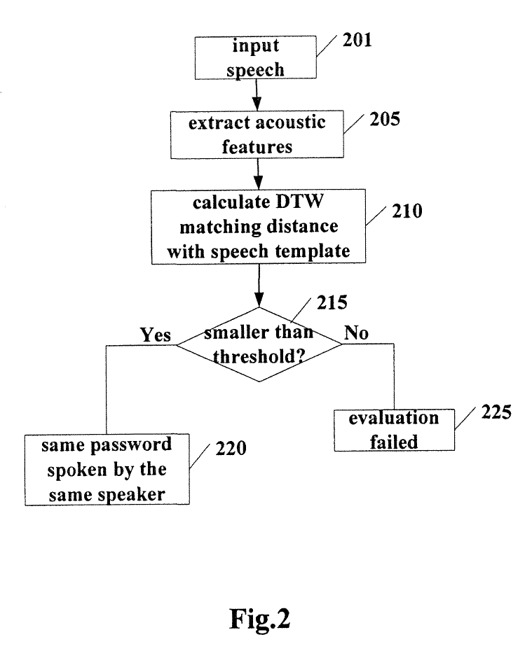

Based on the same concept of the invention, FIG. 2 is a flowchart showing a method for evaluation of speaker authentication according to an embodiment of the present invention. The description of this embodiment will be given below in conjunction with FIG. 2, with a proper omission of the same parts as those in the above-mentioned embodiments.

As shown in FIG. 2, first in Step 201, a user to be authenticated inputs a speech containing a password. Next, in Step 205, acoustic features are extracted from the inputted speech. Same as above-described embodiment, the present invention has no specific limitation to the acoustic features, for instance, MFCC, LPCC or other coefficients obtained based on energy, fundamental tone frequency, or wavelet analysis may be used, as long as they can express the personal speech features of a speaker; but the way for getting acoustic features should correspond to that used in the speech template generated during user's enrollment.

Next, in Step 210, a DTW matching distance between the extracted acoustic features and the acoustic features contained in the speech template is calculated. Here, the speech template in this embodiment is the one generated using a method for enrollment of speaker authentication of the embodiment described above, wherein the speech template contains at least the acoustic features corresponding to the password speech and discriminating threshold. The specific method for calculating a DTW matching distance has been described in above embodiments and will not be repeated.

Next, in Step 215, it is determined whether the DTW matching distance is smaller than the discriminating threshold set in the speech template. If so, the inputted speech is determined as the same password spoken by the same speaker in Step 220 and the evaluation is successful; otherwise, the evaluation is determined as failed in Step 225.

From above description it can be seen that, if the method for evaluation of speaker authentication of this embodiment is adopted, a speech template generated by using a method for enrollment of speaker authentication of the embodiment described above may be used to make evaluation of a user's speech. Since a user can design and select a password text by himself/herself without the need of a system administrator or developer's participation, so that the evaluation process becomes more convenient and gets better security. Furthermore, the resolution of a password speech may be ensured and the security of authentication may be enhanced.

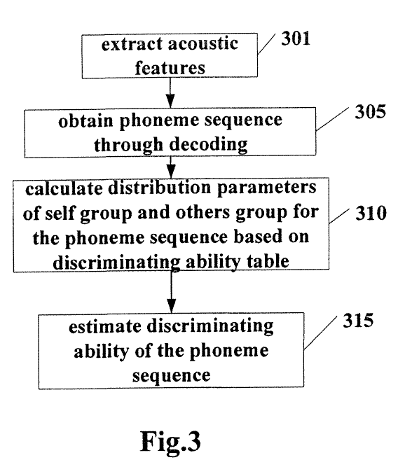

Based on the same concept of the invention, FIG. 3 is a flowchart showing a method for estimating discriminating ability of a speech according to an embodiment of the present invention. The description of this embodiment will be given below in conjunction with FIG. 3, with a proper omission of the same parts as those in the above-mentioned embodiments.

As shown in FIG. 3, first in Step 301, acoustic features are extracted from the speech to be estimated. Same as above-described embodiment, the present invention has no specific limitation to the acoustic features, for instance, MFCC, LPCC or other coefficients obtained based on energy, fundamental tone frequency, or wavelet analysis may be used, as long as they can express the personal speech features of a speaker.

Next, in Step 305, the extracted acoustic features are decoded to obtain a corresponding phoneme sequence. Same as the above-described embodiments, HMM, ANN, or other models may be used; as to the searching algorithms, various decoder algorithms such as Viterbi, A*, and others may be used, as long as a corresponding phoneme sequence can be obtained from the acoustic features.

Next, in Step 310, based on a phoneme discriminating ability table, distribution parameters,

$$N ( {\sum }_{n} {μ}_{cn} , {\sum }_{n} {σ}_{cn}^{2} )$$

and

$$N ( {\sum }_{n} {μ}_{i n} , {\sum }_{n} {σ}_{i n}^{2} ) ,$$

of the phoneme sequence are calculated for the self group and others group respectively. Specifically, similar to Step 115 in the above embodiment, in the phoneme discriminating table there are recorded, respectively according to each phoneme, mean μ_{c} and variance σ_{c}² of the distribution of the self group and mean μᵢ and variance σ_{c}² of the distribution of the others group obtained through statistics. Based on the phoneme discriminating table, distribution parameters

$$N ( {\sum }_{n} {μ}_{cn} , {\sum }_{n} {σ}_{cn}^{2} )$$

and

$$N ( {\sum }_{n} {μ}_{i n} , {\sum }_{n} {σ}_{i n}^{2} )$$

of two groups (self group and others group) of matching distances for the whole phoneme sequence are calculated. Next, in Step 315, the discriminating ability of the phoneme sequence is estimated based on the distribution parameters

$$N ( {\sum }_{n} {μ}_{cn} , {\sum }_{n} {σ}_{cn}^{2} )$$

of the self group and the distribution parameters

$$N ( {\sum }_{n} {μ}_{i n} , {\sum }_{n} {σ}_{i n}^{2} )$$

of the others group calculated above. Similar to above embodiments, one of the following ways may be used:

1) calculating overlapping area of these two distributions; determining if the overlapping area is smaller than a predetermined value.

b) calculating equal error rate (EER); determining if the equal error rate is smaller than a predetermined value.

c) calculating false reject rate (FRR) when the false accept rate (FAR) is set to a predetermined value; determining if the false reject rate (FRR) is smaller than a predetermined value.

From above descriptions it can be seen that, if the method for estimating discriminating ability of a speech of this embodiment is adopted, the discriminating ability of a speech can be estimated automatically without the need of a system administrator or developer's participation, so that the convenience and security may be enhanced for the applications (such as speech authentication) that use discriminating ability of a speech.

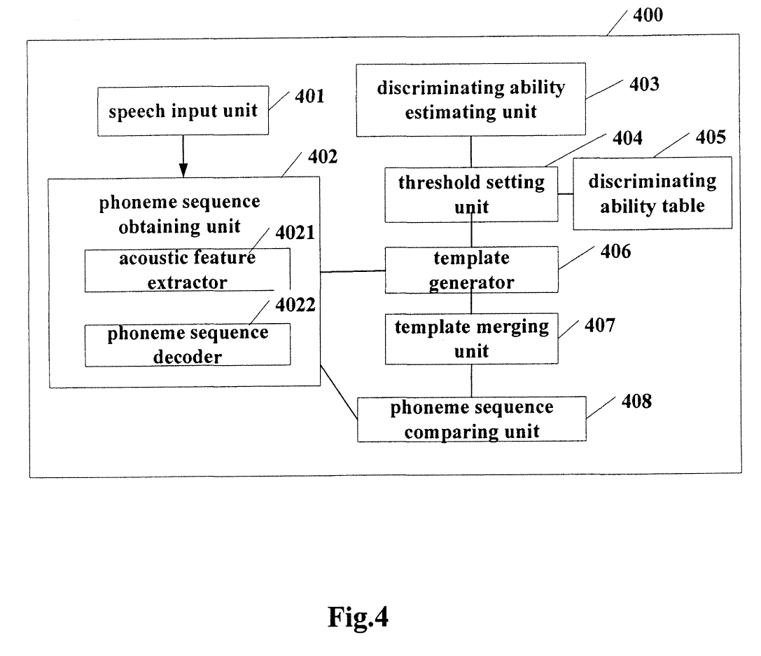

Based on the same concept of the invention, FIG. 4 is a block diagram showing an apparatus for enrollment of speaker authentication according to an embodiment of the present invention. The description of this embodiment will be given below in conjunction with FIG. 4, with a proper omission of the same parts as those in the above-mentioned embodiments.

As shown in FIG. 4, the apparatus 400 for enrollment of speaker authentication of this embodiment comprises: a speech input unit 401 configured to input a speech containing a password that is spoken by a speaker; a phoneme sequence obtaining unit 402 configured to obtain a phoneme sequence from the inputted speech; a discriminating ability estimating unit 403 configured to estimate discriminating ability of the phoneme sequence based on a discriminating ability table 405 that includes a discriminating ability for each phoneme; a threshold setting unit 404 configured to set a discriminating threshold for said speech; and a template generator 406 configured to generate a speech template for said speech.

Furthermore, the phoneme sequence obtaining unit 402 shown in FIG. 4 further includes: an acoustic feature extractor 4021 configured to extract acoustic features from the inputted speech; and a phoneme sequence decoder 4022 configured to decode the extracted acoustic features to obtain a corresponding phoneme sequence.

Similar to above-described embodiments, the phoneme discriminating table 405 of this embodiment records, respectively corresponding to each phoneme, mean μ_{c} and variance σ^{c} of the distribution of the self group and mean μᵢ and variance σᵢ² of the distribution of the others group obtained through statistics.

Besides, though not shown in the figure, the apparatus 400 for enrollment of speaker authentication further includes: a distribution parameter calculator configured to calculate the distribution parameters

$$N ( {\sum }_{n} {μ}_{cn} , {\sum }_{n} {σ}_{cn}^{2} )$$

of self group and the distribution parameters

$$N ( {\sum }_{n} {μ}_{i n} , {\sum }_{n} {σ}_{i n}^{2} )$$

of others group for the phoneme sequence based on the discriminating ability table 405. The discriminating ability estimating unit 403 is configured to determine whether the discriminating ability of the phoneme sequence is enough based on the distribution parameter

$$N ( {\sum }_{n} {μ}_{cn} , {\sum }_{n} {σ}_{cn}^{2} )$$

of self group and the distribution parameter

$$N ( {\sum }_{n} {μ}_{i n} , {\sum }_{n} {σ}_{i n}^{2} )$$

of others group calculated.

Besides, preferably, the discriminating ability estimating unit 403 is configured to calculate overlapping area of the distribution of self group and the distribution of others group, based on the distribution parameter

$$N ( {\sum }_{n} {μ}_{cn} , {\sum }_{n} {σ}_{cn}^{2} )$$

of self group and the distribution parameter

$$N ( {\sum }_{n} {μ}_{i n} , {\sum }_{n} {σ}_{i n}^{2} )$$

of others group for the phoneme sequence; and to determine the discriminating ability of the phoneme sequence is enough if the overlapping area is smaller than a predetermined value, otherwise to determine the discriminating ability of the phoneme sequence is not enough.

Alternatively, the discriminating ability estimating unit 403 is configured to calculate equal error rate (EER) based on the distribution parameter

$$N ( {\sum }_{n} {μ}_{cn} , {\sum }_{n} {σ}_{cn}^{2} )$$

of self group and the distribution parameter

$$N ( {\sum }_{n} {μ}_{i n} , {\sum }_{n} {σ}_{i n}^{2} )$$

of others group for the phoneme sequence; and to determine the discriminating ability of the phoneme sequence is enough if the equal error rate is less than a predetermined value, otherwise to determine the discriminating ability of the phoneme sequence is not enough.

Alternatively, the discriminating ability estimating unit 403 is configured to calculate false reject rate (FRR) when false accept rate (FAR) is set to a predetermined value based on the distribution parameter

$$N ( {\sum }_{n} {μ}_{cn} , {\sum }_{n} {σ}_{cn}^{2} )$$

of self group and the distribution parameter

$$N ( {\sum }_{n} {μ}_{i n} , {\sum }_{n} {σ}_{i n}^{2} )$$

of others group for the phoneme sequence; and to determine the discriminating ability of the phoneme sequence is enough if the false reject rate is less than a predetermined value, otherwise to determine the discriminating ability of the phoneme sequence is not enough.

Similar to above embodiments, the threshold setting unit 404 in this embodiment may use one of the following ways to set a discriminating threshold:

1) setting the discriminating threshold as the cross point of the distribution curve of self group and the distribution curve of others group for the phoneme sequence.

2) setting the discriminating threshold as a threshold corresponding to equal error rate.

3) setting the discriminating threshold as a threshold that makes false accept rate a predetermined value.

Besides, as shown in FIG. 4, the apparatus 400 for enrollment of speaker authentication in this embodiment further includes: a phoneme sequence comparing unit 408 configured to compare two phoneme sequences respectively corresponding to two speeches inputted successively; and a template merging unit 407 configured to merge speech template.

The apparatus 400 for enrollment of speaker authentication and its components in this embodiment may be constructed with specialized circuits or chips, and also can be implemented by executing corresponding programs through a computer (processor). Furthermore, the apparatus 400 for enrollment of speaker authentication in this embodiment can operationally implement the method for enrollment of speaker authentication in the embodiment described above in conjunction with FIG. 1.

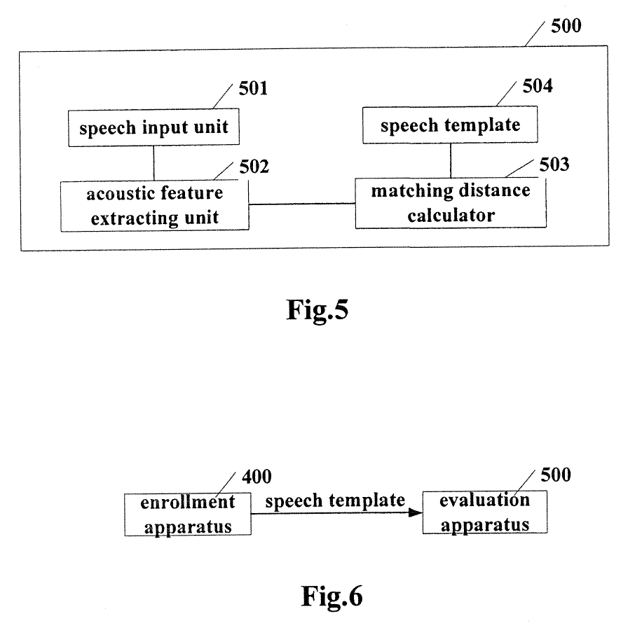

Based on the same concept of the invention, FIG. 5 is a block diagram showing an apparatus for evaluation of speaker authentication according to an embodiment of the present invention. The description of this embodiment will be given below in conjunction with FIG. 5, with a proper omission of the same parts as those in the above-mentioned embodiments.

As shown in FIG. 5, the apparatus 500 for evaluation of speaker authentication in this embodiment comprises: a speech input unit 501 configured to input a speech; an acoustic feature extractor 502 configured to extract acoustic features from the speech inputted by the speech input unit 501; a matching distance calculator 503 configured to calculate DTW matching distance of the extracted acoustic features and a corresponding speech template 504 that is generated by using a method for enrollment of speaker authentication according to the embodiment described above, wherein the speech template 504 contains the acoustic features and discriminating threshold used during user's enrollment. The apparatus 500 for evaluation of speaker authentication in this embodiment is designed to determine the inputted speech is an enrolled password speech spoken by the speaker if the DTW matching distance calculated by the matching distance calculator 503 is smaller than the predetermined discriminating threshold, otherwise the evaluation is determined as failed.

The apparatus 500 for evaluation of speaker authentication and its components in this embodiment may be constructed with specialized circuits or chips, and also can be implemented by executing corresponding programs through a computer (processor). Furthermore, the apparatus 500 for evaluation of speaker authentication in this embodiment can operationally implement the method for evaluation of speaker authentication in the embodiment described above in conjunction with FIG. 2.

Based on the same concept of the invention, FIG. 6 is a block diagram showing a system for speaker authentication according to an embodiment of the present invention. The description of this embodiment will be given below in conjunction with FIG. 6, with a proper omission of the same parts as those in the above-mentioned embodiments.

As shown in FIG. 6, the system for speaker authentication in this embodiment comprises: an apparatus 400 for enrollment of speaker authentication, which can be an apparatus for enrollment of speaker authentication described in an above-mentioned embodiment; and an apparatus for evaluation of speaker authentication, which can be an apparatus 500 for evaluation of speaker authentication described in an above-mentioned embodiment. The speaker template generated by the enrollment apparatus 400 is transferred to the evaluation apparatus 500 via any communication ways, such as a network, an internal channel, a disk or other recording media.

Thus, if the system for speaker authentication of this embodiment is adopted, a user can use the enrollment apparatus 400 to design and select a password text by himself/herself without the need of a system administrator or developer's participation, and can use the evaluation apparatus 500 to make speech evaluation, so that the user can make enrollment more conveniently and get better security. Furthermore, since the system can automatically estimate the discriminating ability of a password speech during user's enrollment, a password speech without enough discriminating ability may be prevented and the security of authentication may be enhanced.

Though a method and apparatus for enrollment of speaker authentication, a method and apparatus for evaluation of speaker authentication, a method for estimating discriminating ability of a speech, and a system for speaker authentication have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

1. A method for enrollment of speaker authentication, comprising:
inputting a speech containing a password that is spoken by a speaker;
obtaining a phoneme sequence from said inputted speech;
estimating discriminating ability of the phoneme sequence based on a discriminating ability table that includes a discriminating ability for each phoneme;
setting a discriminating threshold for said speech; and
generating a speech template for said speech.

2. The method for enrollment of speaker authentication according to claim 1, wherein said step of obtaining a phoneme sequence from said inputted speech comprises:
extracting acoustic features from said inputted speech; and
decoding said extracted acoustic features to obtain a corresponding phoneme sequence.

3. The method for enrollment of speaker authentication according to claim 1, wherein said discriminating ability table, for each phoneme, comprises: mean μ_{c} and variance σ_{c}² of a statistic DTW matching distance distribution of acoustic features of self group, and mean μᵢ and variance σᵢ² of a statistic DTW matching distance distribution of acoustic features of others group;
said step of estimating discriminating ability of the phoneme sequence comprises:
calculating distribution parameters
$$N ( {\sum }_{n} {μ}_{cn} , {\sum }_{n} {σ}_{cn}^{2} )$$
of self group and distribution parameters
$$N ( {\sum }_{n} {μ}_{in} , {\sum }_{n} {σ}_{in}^{2} )$$
of others group for said phoneme sequence based on said discriminating ability table; and
determining whether the discriminating ability of said phoneme sequence is enough based on said distribution parameters
$$N ( {\sum }_{n} {μ}_{cn} , {\sum }_{n} {σ}_{cn}^{2} )$$
of self group and said distribution parameters
$$N ( {\sum }_{n} {μ}_{in} , {\sum }_{n} {σ}_{in}^{2} )$$
of others group calculated.

4. The method for enrollment of speaker authentication according to claim 3, wherein said step of determining whether the discriminating ability of said phoneme sequence is enough comprises:
calculating overlapping area of the distribution of self group and the distribution of others group, based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{in} , {\sum }_{n} {σ}_{in}^{2} )$$
of others group; and
determining the discriminating ability of said phoneme sequence is enough if said overlapping area is smaller than a predetermined value, otherwise determining the discriminating ability of said phoneme sequence is not enough.

5. The method for enrollment of speaker authentication according to claim 3, wherein said step of determining whether the discriminating ability of said phoneme sequence is enough comprises:
calculating equal error rate (EER) based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{in} , {\sum }_{n} {σ}_{in}^{2} )$$
of others group; and
determining the discriminating ability of said phoneme sequence is enough if said equal error rate is less than a predetermined value, otherwise determining the discriminating ability of said phoneme sequence is not enough.

6. The method for enrollment of speaker authentication according to claim 3, wherein said step of determining whether the discriminating ability of said phoneme sequence is enough comprises:
calculating false reject rate (FRR) when false accept rate (FAR) is set to a desired value based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{in} , {\sum }_{n} {σ}_{in}^{2} )$$
of others group; and
determining the discriminating ability of said phoneme sequence is enough if said false reject rate is less than a predetermined value, otherwise determining the discriminating ability of said phoneme sequence is not enough.

7. The method for enrollment of speaker authentication according to any one of claims 4-6, wherein said step of setting a discriminating threshold for said speech comprises:
setting the discriminating threshold as the cross point of the distribution curve of self group and the distribution curve of others group of said phoneme sequence.

8. The method for enrollment of speaker authentication according to any one of claims 4-6, wherein said step of setting a discriminating threshold for said speech comprises:
setting the discriminating threshold as a threshold corresponding to equal error rate.

9. The method for enrollment of speaker authentication according to any one of claims 4-6, wherein said step of setting a discriminating threshold for said speech comprises:
setting the discriminating threshold as a threshold that makes false accept rate a desired value.

10. The method for enrollment of speaker authentication according to any one of claims 2-9, wherein said speech template comprises said extracted acoustic features and said discriminating threshold.

11. The method for enrollment of speaker authentication according to any one of the preceding claims, further comprising: prompting the speaker to change a password when it is determined that the discriminating ability of said phoneme sequence is not enough.

12. The method for enrollment of speaker authentication according to any one of the preceding claims, further comprising:
re-inputting a speech spoken by the speaker for confirmation after the step of generating a speech template;
obtaining a phoneme sequence from the re-inputted speech;
comparing the phoneme sequence corresponding to the re-inputted speech this time with the phoneme sequence corresponding to the inputted speech last time; and
merging the speech template if said two phoneme sequences are consistent.

13. A method for evaluation of speaker authentication, comprising:
inputting a speech; and
determining whether the inputted speech is a enrolled password speech spoken by the speaker according to a speech template that is generated by using the method for enrollment of speaker authentication according to any one of the preceding claims.

14. The method for evaluation of speaker authentication according to claim 13, wherein said step of determining whether the inputted speech is a enrolled password speech spoken by the speaker comprises:
extracting acoustic features from said inputted speech;
calculating the DTW matching distance of said extracted acoustic features and said speech template; and
determining whether the inputted speech is a enrolled password speech spoken by the speaker through comparing said calculated DTW matching distance with the predefined discriminating threshold.

15. A method for estimating discriminating ability of a speech, comprising:
obtaining a phoneme sequence from said speech; and
estimating discriminating ability of the phoneme sequence based on a discriminating ability table that includes a discriminating ability for each phoneme.

16. The method for estimating discriminating ability of a speech according to claim 15, wherein said step of obtaining a phoneme sequence comprises:
extracting acoustic features from said speech; and
decoding said extracted acoustic features to obtain a corresponding phoneme sequence.

17. The method for estimating discriminating ability of a speech according to claim 15, wherein said discriminating ability table, for each phoneme, comprises: mean μ_{c} and variance σ_{c}² of a statistic DTW matching distance distribution of acoustic features of self group, and mean μᵢ and variance σᵢ² of a statistic DTW matching distance distribution of acoustic features of others group;
said step of estimating discriminating ability of the phoneme sequence comprises:
calculating distribution parameters
$$N ( {\sum }_{n} {μ}_{cn} , {\sum }_{n} {σ}_{cn}^{2} )$$
of self group and distribution parameters
$$N ( {\sum }_{n} {μ}_{i n} , {\sum }_{n} {σ}_{i n}^{2} )$$
of others group for said phoneme sequence based on said discriminating ability table; and
estimating the discriminating ability of said phoneme sequence based on said distribution parameters
$$N ( {\sum }_{n} {μ}_{cn} , {\sum }_{n} {σ}_{cn}^{2} )$$
of self group and said distribution parameters
$$N ( {\sum }_{n} {μ}_{i n} , {\sum }_{n} {σ}_{i n}^{2} )$$
of others group calculated.

18. The method for estimating discriminating ability of a speech according to claim 17, wherein said step of estimating the discriminating ability of said phoneme sequence comprises:
calculating overlapping area of the distribution of self group and the distribution of others group, based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and
determining whether said overlapping area is less than a predetermined value.

19. The method for estimating discriminating ability of a speech according to claim 17, wherein said step of estimating the discriminating ability of said phoneme sequence comprises:
calculating equal error rate (EER) based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and
determining whether said equal error rate is less than a predetermined value.

20. The method for estimating discriminating ability of a speech according to claim 17, wherein said step of estimating the discriminating ability of said phoneme sequence comprises:
calculating false reject rate (FRR) when false accept rate (FAR) is set to a desired value based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and
determining whether the false reject rate is less than a predetermined value.

21. An apparatus for enrollment of speaker authentication, comprising:
a speech input unit configured to input a speech containing a password that is spoken by a speaker;
a phoneme sequence obtaining unit configured to obtain a phoneme sequence from said inputted speech;
a discriminating ability estimating unit configured to estimate discriminating ability of the phoneme sequence based on a discriminating ability table that includes a discriminating ability for each phoneme;
a threshold setting unit configured to set a discriminating threshold for said speech; and
a template generator configured to generate a speech template for said speech.

22. The apparatus for enrollment of speaker authentication according to claim 21, wherein said phoneme sequence obtaining unit comprises:
an acoustic feature extractor configured to extract acoustic features from said inputted speech; and
a phoneme sequence decoder configured to decode said extracted acoustic features to obtain a corresponding phoneme sequence.

23. The apparatus for enrollment of speaker authentication according to claim 21, wherein said discriminating ability table, for each phoneme, comprises: mean μ_{c} and variance σ_{c}^{c} of a statistic DTW matching distance distribution of acoustic features of self group, and mean μᵢ a and variance σᵢ² of a statistic DTW matching distance distribution of acoustic features of others group;
said apparatus for enrollment of speaker authentication further comprises:
a distribution parameter calculator configured to calculate distribution parameters
$$N ( {\sum }_{n} {μ}_{cn} , {\sum }_{n} {σ}_{cn}^{2} )$$
of self group and distribution parameters
$$N ( {\sum }_{n} {μ}_{i n} , {\sum }_{n} {σ}_{i n}^{2} )$$
of others group for said phoneme sequence based on said discriminating ability table; and
said discriminating ability estimating unit is configured to determine whether the discriminating ability of said phoneme sequence is enough based on said distribution parameters
$$N ( {\sum }_{n} {μ}_{cn} , {\sum }_{n} {σ}_{cn}^{2} )$$
of self group and said distribution parameters
$$N ( {\sum }_{n} {μ}_{i n} , {\sum }_{n} {σ}_{i n}^{2} )$$
of others group calculated.

24. The apparatus for enrollment of speaker authentication according to claim 23, wherein said discriminating ability estimating unit is configured to calculate overlapping area of the distribution of self group and the distribution of others group, based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and to determine the discriminating ability of said phoneme sequence is enough if said overlapping area is smaller than a predetermined value, otherwise determining the discriminating ability of said phoneme sequence is not enough.

25. The apparatus for enrollment of speaker authentication according to claim 23, wherein said discriminating ability estimating unit is configured to calculate equal error rate (EER) based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and to determine the discriminating ability of said phoneme sequence is enough if said equal error rate is less than a predetermined value, otherwise determining the discriminating ability of said phoneme sequence is not enough.

26. The apparatus for enrollment of speaker authentication according to claim 23, wherein said discriminating ability estimating unit is configured to calculate false reject rate (FRR) when false accept rate (FAR) is set to a desired value based on the distribution parameters
$$N ( {\sum }_{n} {μ}_{cn} , {\sum }_{n} {σ}_{cn}^{2} )$$
of self group and the distribution parameters
$$N ( {\sum }_{n} {μ}_{i n} , {\sum }_{n} {σ}_{i n}^{2} )$$
of others group; and to determine the discriminating ability of said phoneme sequence is enough if said false reject rate is less than a predetermined value, otherwise determining the discriminating ability of said phoneme sequence is not enough.

27. The apparatus for enrollment of speaker authentication according to any one of claims 24-26, wherein said threshold setting unit is configured to set the discriminating threshold as the cross point of the distribution curve of self group and the distribution curve of others group of said phoneme sequence.

28. The apparatus for enrollment of speaker authentication according to any one of claims 24-26, wherein said threshold setting unit is configured to set the discriminating threshold as a threshold corresponding to equal error rate.

29. The apparatus for enrollment of speaker authentication according to any one of claims 24-26, wherein said threshold setting unit is configured to set the discriminating threshold as a threshold that makes false accept rate a desired value.

30. The apparatus for enrollment of speaker authentication according to any one of claims 22-29, wherein said speech template comprises said extracted acoustic features and said discriminating threshold.

31. The apparatus for enrollment of speaker authentication according to any one of claims 21-30, further comprising:
a phoneme sequence comparing unit configured to compare two phoneme sequences respectively corresponding to two speeches inputted successively; and
a template merging unit configured to merge speech template.

32. An apparatus for evaluation of speaker authentication, comprising:
a speech input unit configured to input a speech;
an acoustic feature extractor configured to extract acoustic features from said inputted speech; and
a matching distance calculator configured to calculate the DTW matching distance of said extracted acoustic features and a corresponding speech template that is generated by using the method for enrollment of speaker authentication according to any one of the preceding claims;
wherein said apparatus for evaluation of speaker authentication determines whether the inputted speech is a enrolled password speech spoken by the speaker through comparing said calculated DTW matching distance with the predefined discriminating threshold.

33. A system for speaker authentication, comprising:
the apparatus for enrollment of speaker authentication according to any one of claims 20-31; and
the apparatus for evaluation of speaker authentication according to claim 32.
